(19) United States
(12) Patent Application Publication
(10) Pub. No.: US 2010/0007495 A1
(43) Pub. Date: Jan. 14, 2010

(54) System and Method for Monitoring a Location of a Mobile RFID Reader

(75) Inventor: Hanns-Christian L. Hanebeck, Dallas, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/170,739

(22) Filed: Jul. 10, 2008

(51) Int. Cl. G08B 13/22

(52) U.S. Cl. 340/572.1

(57) ABSTRACT

A system and a method for monitoring a location of a mobile RFID reader are provided. The system includes an active RFID tag disposed on the mobile RFID reader configured to transmit a first RF signal. The system further includes a first stationary RFID reader configured to receive the first RF signal. The first stationary RFID reader is further configured to send a first message having data associated with the first RF signal to a computer. The computer is configured to determine a first location of the mobile RFID reader at a first time based on the data associated with the first RF signal. The computer is further configured to store first location data indicating the first location of the mobile RFID reader in a memory device.

### FIELD OF INVENTION

This application relates to a system and a method for monitoring a location of a mobile RFID reader.

### BACKGROUND OF INVENTION

RFID systems have been utilized to track a location of manufactured goods. However, current RFID systems have not tracked a location of mobile RFID readers that are coupled to movable objects.

The inventor herein has recognized that it would be advantageous to track mobile RFID readers for improved security control for a geographical region and improved business process monitoring in a geographical region.

### SUMMARY OF INVENTION

A method for monitoring a location of a mobile RFID reader in accordance with an exemplary embodiment is provided. The method includes transmitting a first RF signal from an active RFID tag disposed on the mobile RFID reader. The method further includes receiving the first RF signal at a first stationary RFID reader. The method further includes sending a first message having data associated with the first RF signal, from the first stationary RFID reader to a computer. The method further includes determining a first location of the mobile RFID reader at a first time based on the data associated with the first RF signal, utilizing the computer. The method further includes storing first location data indicating the first location of the mobile RFID reader in a memory device, utilizing the computer.

A system for monitoring a location of a mobile RFID reader in accordance with another exemplary embodiment is provided. The system includes an active RFID tag disposed on the mobile RFID reader configured to transmit a first RF signal. The system further includes a first stationary RFID reader configured to receive the first RF signal. The first stationary RFID reader is further configured to send a first message having data associated with the first RF signal to a computer. The computer is configured to determine a first location of the mobile RFID reader at a first time based on the data associated with the first RF signal. The computer is further configured to store first location data indicating the first location of the mobile RFID reader in a memory device.

### BRIEF DESCRIPTION OF DRAWINGS

FIG. 1 is a schematic of a system for monitoring a location of a mobile RFID reader in accordance with an exemplary embodiment;

FIG. 2 is a schematic of an exemplary graphical user interface displayed on a display device in the system of FIG. 1;

FIGS. 3-5 are flowcharts of a method for monitoring a location of a mobile RFID reader in accordance with another exemplary embodiment; and

FIGS. 6-9 are flowcharts of another method for monitoring a location of a mobile RFID reader in accordance with another exemplary embodiment.

### DESCRIPTION OF EXEMPLARY EMBODIMENTS

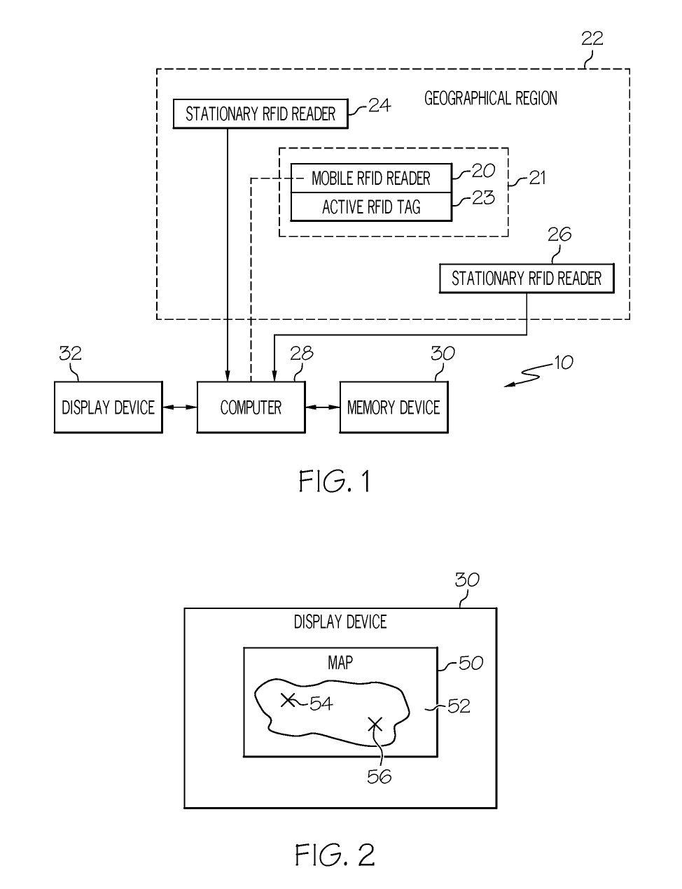

Referring to FIG. 1, a system 10 for monitoring a location of a mobile RFID reader 20 on a vehicle 21 in a geographical region 22 is illustrated. The system 10 includes an active RFID tag 23, stationary RFID readers 24, 26, a computer 28, a memory device 30, and a display device 32. The vehicle 21 can be a mobile forklift device or a rescue vehicle for example.

An advantage of the system 10 is that the system 10 can determine a location of the mobile RFID reader 28 and data acquired by the mobile RFID reader 28 at the location. Thereafter, the location of the mobile RFID reader 28 and the acquired data can be utilized by a user to effectively monitor a business process utilizing the mobile RFID reader 28.

Another advantage of the system 10 is that the system 10 can determine movement of the mobile RFID reader 28 over time and can generate alert messages when the mobile RFID reader 28 does not move greater than a predetermined distance over a time interval. For example, if the mobile RFID reader 20 is coupled to a forklift device, the system 10 could determine the locations of the mobile RFID reader 20 over time to identify whether the forklift device is being effectively utilized in a geographic region such as a manufacturing plant or a loading facility. Further, for example, if the mobile RFID reader 20 is coupled to a rescue vehicle, the system 10 could determine the locations of the mobile RFID reader 20 over time to identify whether the rescue vehicle in a military zone has not moved greater than a predetermined distance over a time interval indicating that the personnel in the rescue vehicle may need assistance.

Another advantage of the system 10 is that the system 10 can determine a location of the mobile RFID reader 28 to determine whether the mobile RFID reader 28 is within a geographical region. If the mobile RFID reader 28 coupled to a vehicle or other moveable device is not within the geographical region, the system 10 can display an alert message indicating possible theft of the vehicle or other moveable devices.

The active RFID tag 23 is coupled to the mobile RFID reader 20. The active RFID tag 23 is configured to transmit an RF signal having: (i) a mobile device identifier value identifying the mobile RFID reader 20, (ii) a date value indicating a current date, (iii) and a first time value indicating a time that the RF signal is transmitted.

The stationary RFID reader 24 is disposed either in a geographical region 22 or proximate to the geographical region 22. The stationary RFID reader 24 is configured to receive the RF signal from the active RFID tag 23 coupled to the mobile RFID reader 20. The stationary RFID reader 24 is further configured to extract from the RF signal the following information: (i) the mobile device identifier value, (ii) the date value, (iii) and the first time value. The stationary RFID reader 24 is further configured to send a first message to the computer 28 having: (i) the mobile device identifier value, (ii) the date value, (iii) the first time value, and (iv) a second time value corresponding to a second time when the stationary RFID reader 24 received in the RF signal from the active RFID tag 23.

The stationary RFID reader 26 is optional in the system 10. The stationary RFID reader 26 is disposed either in the geographical region 22 or proximate to the geographical region 22. The stationary RFID reader 26 is configured to receive the RF signal from the active RFID tag 23 coupled to the mobile RFID reader 20. The stationary RFID reader 26 is further configured to extract from the RF signal the following information: (i) the mobile device identifier value, (ii) the date value, (iii) and the first time value. The stationary RFID reader 26 is further configured to send a second message to the computer 28 having: (i) the mobile device identifier value, (ii) the date value, (iii) the first time value, and (iv) a third time value corresponding to a third time when the stationary RFID reader 24 received in the RF signal from the active RFID tag 23.

The computer 20 operably communicates with the stationary RFID reader 24, the stationary RFID reader 26, the mobile RFID reader 20, the memory device 30, and the display device 32. In one exemplary embodiment, the computer 28 configured to receive the first message from the stationary RFID reader 24. Further, the computer 28 is configured to determine a location of the mobile RFID reader 20 based on the first and second time values in the first message and a known location of the stationary RFID reader 26 utilizing the following equation: location=f(first time value, second time value, known location of stationary RFID reader 26, and known speed of the RF signal).

In another exemplary embodiment, the computer 28 is configured to receive the first and second messages from the stationary RFID readers 24, 26, respectively. Further, the computer 28 is configured to determine a location of the mobile RFID reader 20 based on the first, second and third time values, and known locations of the stationary RFID readers 24, 26 utilizing the following triangulation equation: location=f(first time value, second time value, third time value, known location of stationary RFID reader 26, known location of stationary RFID reader 26, and the known speed of the RF signal).

The memory device 30 is configured to store both data generated by the computer 28 and computer-executable algorithms executed by the computer 28. The memory device 30 is operably coupled to the computer 28.

Referring to FIGS. 1 and 2, the display device 32 is configured to display a graphical user interface having a map of a geographical region and at least one location marker indicating the location of the mobile RFID reader 20. For example, in one exemplary embodiment, the display device 32 is configured to display a graphical user interface 50 having a map 52 of the geographical region 22 and location markers 54, 56 indicating the locations of the mobile RFID reader 20 over time. The display device 32 is operably coupled to the computer 28.

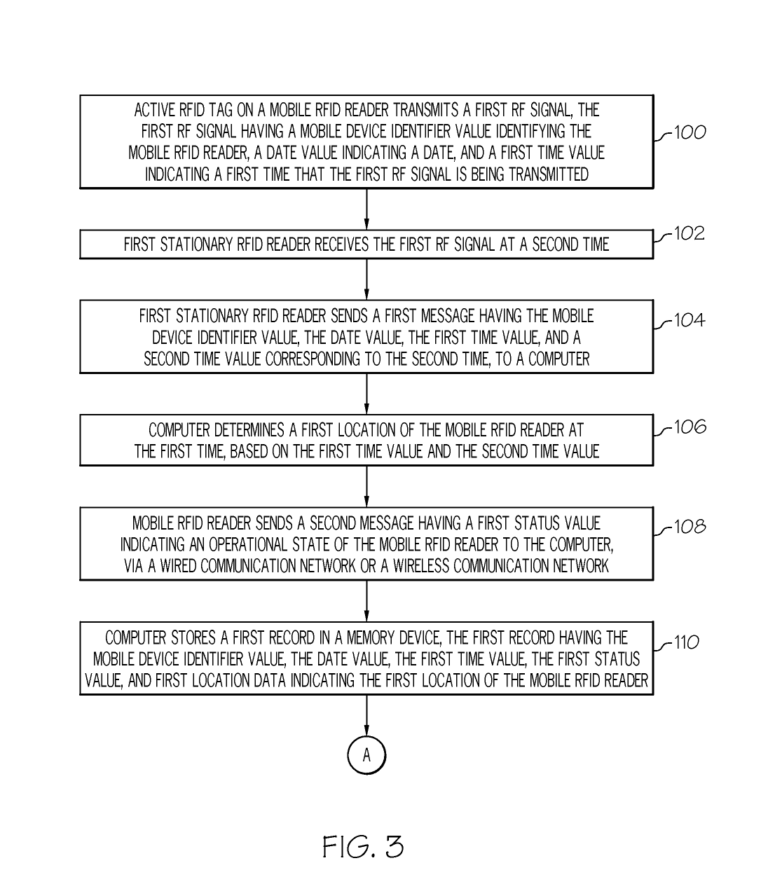

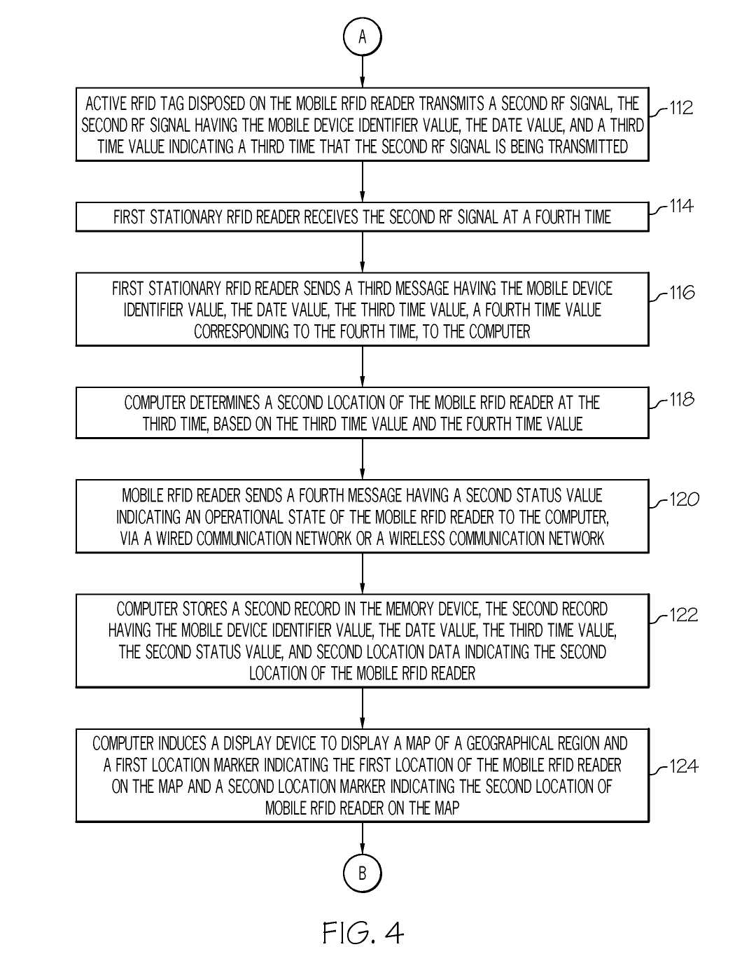

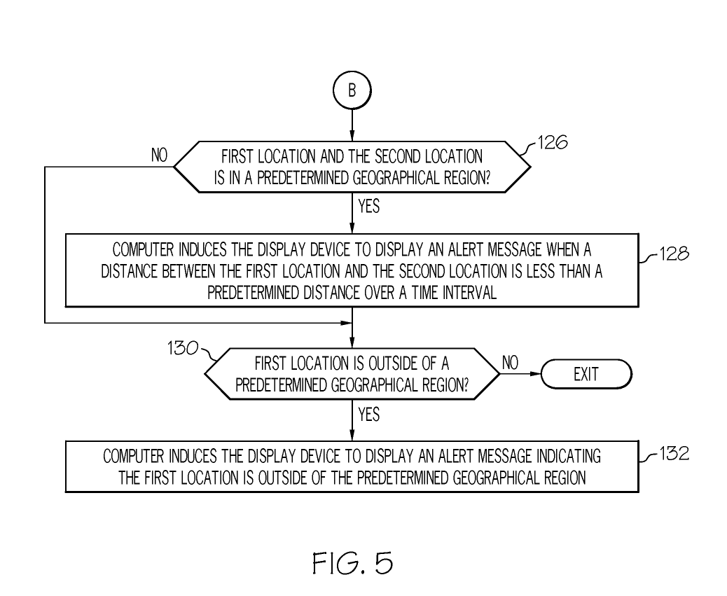

Referring to FIGS. 3-5, a flowchart of a method for monitoring a location of the mobile RFID reader 20 in accordance with an exemplary embodiment is illustrated. The following method utilizes one stationary RFID reader 24 to determine the location of the mobile RFID reader 20.

At step 100, the active RFID tag 23 on the mobile RFID reader 20 transmits a first RF signal. The first RF signal has a mobile device identifier value identifying the mobile RFID reader 20, a date value indicating a date, and a first time value indicating a first time that the first RF signal is transmitted.

At step 102, the stationary RFID reader 24 receives the first RF signal at a second time.

At step 104, the stationary RFID reader 24 sends a first message having the mobile device identifier value, the date value, the first time value, and a second time value corresponding to the second time, to the computer 28.

At step 106, the computer 28 determines a first location of the mobile RFID reader 20 at the first time, based on the first time value and the second time value.

At step 108, the mobile RFID reader 20 sends a second message having a first status value indicating an operational state of the mobile RFID reader 20 to the computer 28, via a wired communication network or a wireless communication network. In one exemplary embodiment, the first status value can indicate whether the mobile RFID reader 20 is operational or is currently being utilized. Further, the second message can contain data acquired by the mobile RFID reader 20 from an RFID tag.

At step 110, the computer 28 stores a first record in the memory device 30. The first record has the mobile device identifier value, the date value, the first time value, the first status value, and first location data indicating the first location of the mobile RFID reader 20. Further, the first record can contain data acquired by the mobile RFID reader 20 from an RFID tag.

At step 112, the active RFID tag 23 disposed on the mobile RFID reader 20 transmits a second RF signal. The second RF signal has the mobile device identifier value, the date value, and a third time value indicating a third time that the second RF signal is being transmitted.

At step 114, the stationary RFID reader 24 receives the second RF signal at a fourth time.

At step 116, the stationary RFID reader 24 sends a third message having the mobile device identifier value, the date value, the third time value, a fourth time value corresponding to the fourth time, to the computer 28.

At step 118, the computer 28 determines a second location of the mobile RFID reader 20 at the third time, based on the third time value and the fourth time value.

At step 120, the mobile RFID reader 20 sends a fourth message having a second status value indicating an operational state of the mobile RFID reader 20 to the computer 28, via a wired communication network or a wireless communication network. Further, the fourth message can contain data acquired by the mobile RFID reader 20 from an RFID tag.

At step 122, the computer 28 stores a second record in the memory device 30. The second record has the mobile device identifier value, the date value, the third time value, the second status value, and second location data indicating the second location of the mobile RFID reader 20. Further, the second record can contain data acquired by the mobile RFID reader 20 from an RFID tag.

At step 124, the computer 28 induces the display device 32 to display a map of the geographical region 22 and a first location marker indicating the first location of the mobile RFID reader 20 on the map and a second location marker indicating the second location of mobile RFID reader 20 on the map.

At step 126, the computer 28 makes a determination as to whether the first location and the second location is in the predetermined geographical region 22. If the value of step 126 equals “yes”, the method of advances to step 128. Otherwise, the method advances to step 130.

At step 128, the computer 28 induces the display device 32 to display an alert message when a distance between the first location and the second location is less than a predetermined distance over a time interval. For example, alert message could alert the user that a mobile rescue unit in a dangerous geographical region is not moving. After step 128, the method advances to step 130.

At step 130, the computer 28 makes a determination as to whether the first location is outside of the predetermined geographical region. If the value of step 130 equals “yes”, the method advances to step 132. Otherwise, the method is exited.

At step 132, the computer 28 induces the display device 32 to display an alert message indicating the first location is outside of the predetermined geographical region. For example, the alert message could alert the user when a mobile device holding the mobile RFID reader 20 thereon is being moved out of a building or other geographical region indicating theft of the mobile device. After step 132, the method is exited.

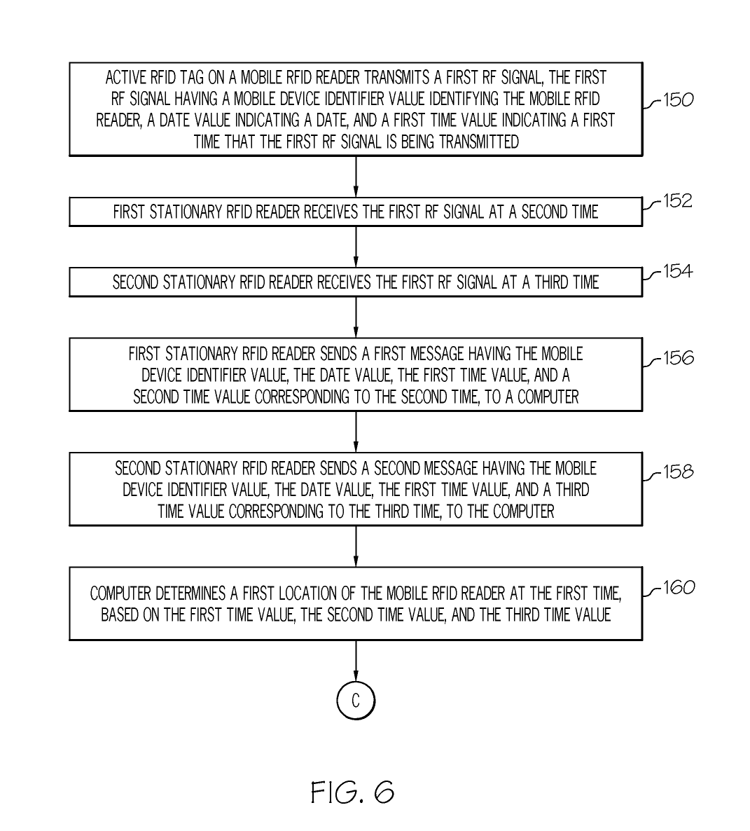

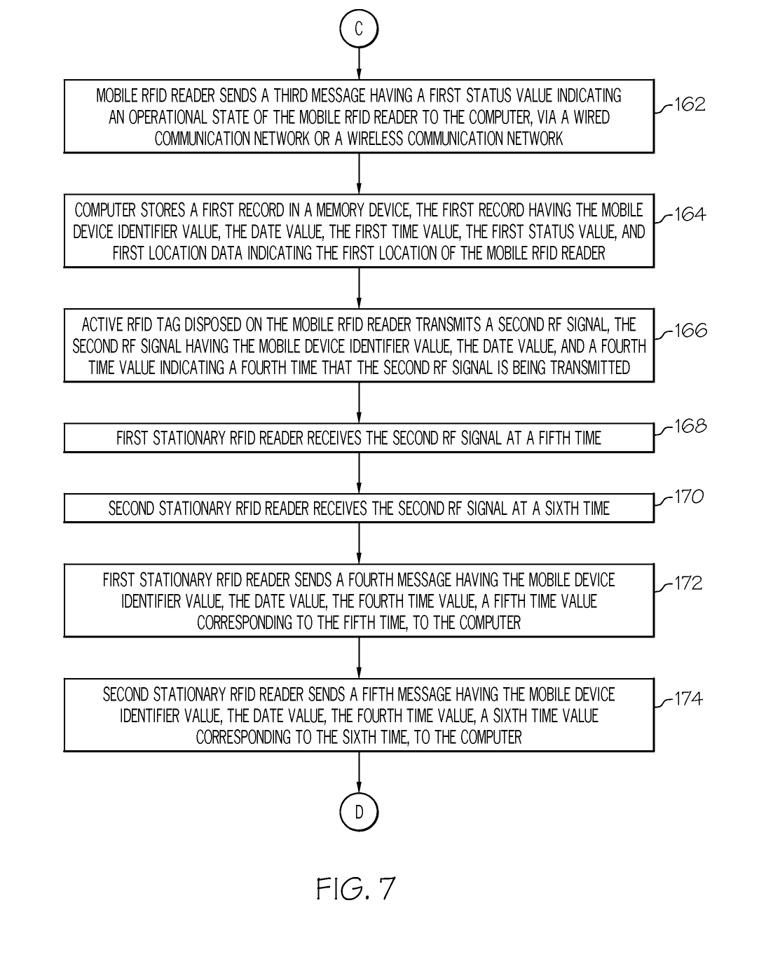

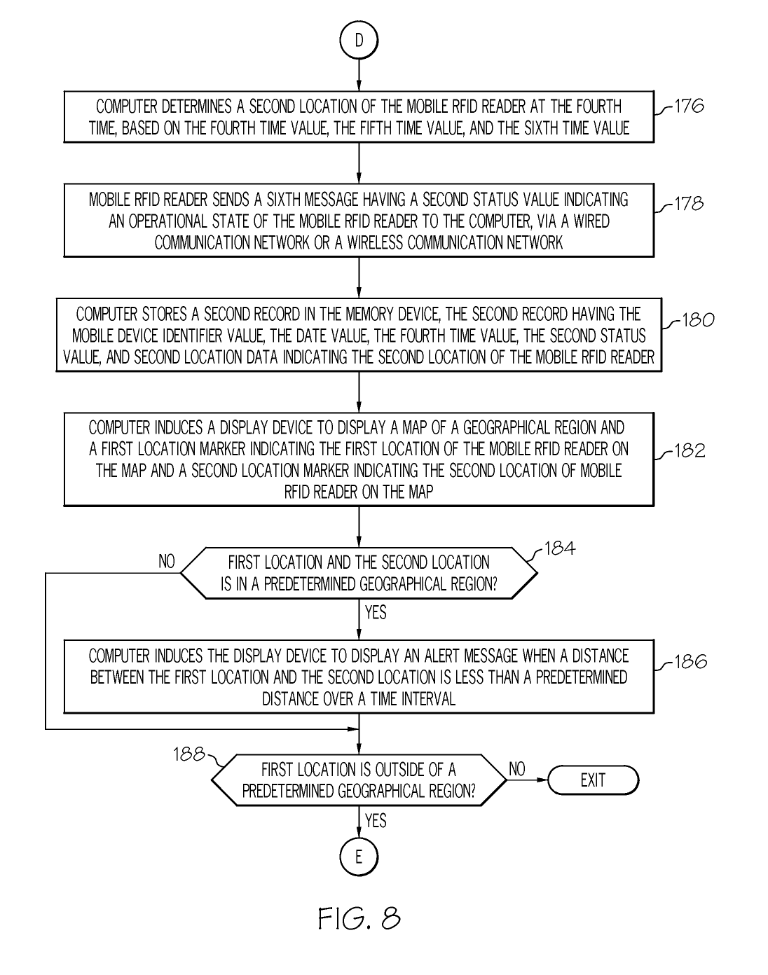

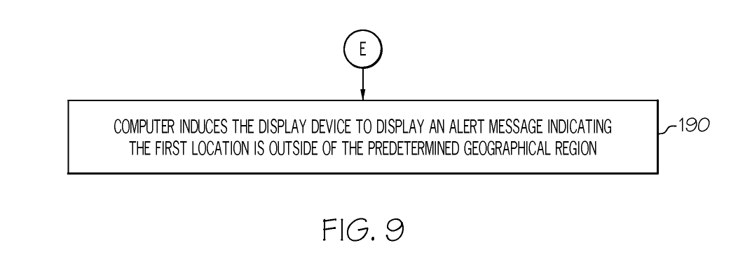

Referring to FIGS. 6-9, a flowchart of another method for monitoring a location of a mobile RFID reader 20 in accordance with another exemplary embodiment is illustrated. The following method utilizes two stationary RFID readers to triangulate the location of the mobile RFID reader 20. Of course, in alternative embodiments, more than two stationary RFID readers could be utilized to determine the location of the mobile RFID reader 20.

At step 150, the active RFID tag 20 on the mobile RFID reader 20 transmits a first RF signal. The first RF signal has a mobile device identifier value identifying the mobile RFID reader, a date value indicating a date, and a first time value indicating a first time that the first RF signal is transmitted.

At step 152, the stationary RFID reader 24 receives the first RF signal at a second time.

At step 154, the stationary RFID reader 26 receives the first RF signal at a third time.

At step 156, the stationary RFID reader 24 sends a first message having the mobile device identifier value, the date value, the first time value, and a second time value corresponding to the second time, to the computer 28.

At step 158, the stationary RFID reader 26 sends a second message having the mobile device identifier value, the date value, the first time value, and a third time value corresponding to the third time, to the computer 28.

At step 160, the computer 28 determines a first location of the mobile RFID reader 20 at the first time, based on the first time value, the second time value, and the third time value.

At step 162, the mobile RFID reader 20 sends a third message having a first status value indicating an operational state of the mobile RFID reader 20 to the computer 28, via a wired communication network or a wireless communication network. Further, the third message can contain data acquired by the mobile RFID reader 20 from an RFID tag.

At step 164, the computer 28 stores a first record in the memory device 30. The first record has the mobile device identifier value, the date value, the first time value, the first status value, and first location data indicating the first location of the mobile RFID reader 20. Further, the first record can contain data acquired by the mobile RFID reader 20 from an RFID tag.

At step 166, the active RFID tag 23 disposed on the mobile RFID reader 20 transmits a second RF signal. The second RF signal has the mobile device identifier value, the date value, and a fourth time value indicating a fourth time that the second RF signal is transmitted.

At step 168, the stationary RFID reader 24 receives the second RF signal at a fifth time.

At step 170, the stationary RFID reader 26 receives the second RF signal at a sixth time.

At step 172, the stationary RFID reader 24 sends a fourth message having the mobile device identifier value, the date value, the fourth time value, a fifth time value corresponding to the fifth time, to the computer 28.

At step 174, the stationary RFID reader 26 sends a fifth message having the mobile device identifier value, the date value, the fourth time value, a sixth time value corresponding to the sixth time, to the computer 28.

At step 176, the computer 28 determines a second location of the mobile RFID reader 20 at the fourth time, based on the fourth time value, the fifth time value, and the sixth time value. In particular, the computer 28 utilizes a triangulation method known to those skilled in the art to determine the location of the RFID reader 20 based upon the fourth time value, the fifth time value, and the sixth time value.

At step 178, the mobile RFID reader 20 sends a sixth message having a second status value indicating an operational state of the mobile RFID reader to the computer 28, via a wired communication network or a wireless communication network. Further, the sixth message can contain data acquired by the mobile RFID reader 20 from an RFID tag.

At step 180, the computer 28 stores a second record in the memory device 30. The second record has the mobile device identifier value, the date value, the fourth time value, the second status value, and second location data indicating the second location of the mobile RFID reader 20. Further, the second record can contain data acquired by the mobile RFID reader 20 from an RFID tag.

At step 182, the computer 28 induces the display device 32 to display a map of the geographical region 42 and a first location marker indicating the first location of the mobile RFID reader 20 on the map and a second location marker indicating the second location of mobile RFID reader 20 on the map.

At step 184, the computer 28 makes a determination as to whether the first location and the second location is in the predetermined geographical region 22. If the value of step 184 equals “yes”, the method advances to step 186. Otherwise, the method advances to step 188.

At step 186, the computer 28 induces the display device 32 to display an alert message when a distance between the first location and the second location is less than a predetermined distance over a time interval. After step 186, the method advances to step 188.

At step 188, the computer 28 makes a determination as to whether the first location is outside of the predetermined geographical region 22. The value of step 188 equals “yes”, the method advances to step 190. Otherwise, the method is exited.

At step 190, the computer 28 induces the display device 32 to display an alert message indicating the first location is outside of the predetermined geographical region. After step 190, the method is exited.

An explanation of some additional advantages of the system 10 will now be explained. In particular, the system 10 can be utilized to allow a user to monitor a movement of the mobile RFID reader 20 on the display device 32 as the mobile RFID reader 20 moves through a facility. The knowledge of the location of the mobile RFID reader 20 over time and where it is being utilized over time allows the user to draw conclusions about business processes utilized in the facility. For example, a mobile RFID reader 20 disposed on a truck can be monitored to determine when a specific loading dock area in the facility is being utilized, and where trucks are being loaded and unloaded in the facility, and also which goods are being received in the trucks. In one exemplary embodiment, location data associated with the mobile RFID reader and data that has been gathered by the mobile RFID reader 20 can be associated together. Accordingly, the system 10 allows the user to view the combined data to monitor business processes in the facility.

Another advantage of the system 10 is that a user can be prompted to log into the mobile RFID reader 20, to allow a supervisor to monitor a productivity of the user. In particular, usage data associated with the mobile RFID reader 20 and location data can be utilized by a supervisor to correlate user, time, and location data to a product or a good that was handled by the user. Accordingly, it is possible to determine who implemented a specific task or business process, a location where the task or process was implemented, and a time duration to complete the task or process. For example, a handling time of a pallet in a facility can be determined. Further, a supervisor can draw conclusions about the business processes from the usage data and location data. For example, the supervisor could identify a need for additional training of an employee or could determine that a particular type of pallet should not been utilized for a particular product.

Another advantage of the system 10 is that the system can be utilized for emergency response purposes in specific geographical regions. For example by determining a location of the mobile RFID reader 20 and users associated with the reader, and determining that the mobile RFID reader is in close proximity to a relatively dangerous region and that the RFID reader 20 is not moving, a supervisor could determine that an emergency response should be initiated. Another advantage of the system 10 is that the system can readily determine a location of the mobile RFID reader 20 that is needed, which could be difficult to find if a search was manually performed.

Still another advantage of the system 10 is that the system could be utilized to monitor a battery life of a mobile device that is carrying the mobile RFID reader 20 and to trigger alerts when batteries associated with the mobile device need to be charged. For example, a supervisor at an end of a work shift could determine mobile devices that have not been placed in battery charging stations.

Still another advantage of the system 10 is that the system can display a location of the mobile RFID reader 20 over time to provide historical data indicating usage of the mobile RFID reader 20 over time as the reader relates to specific users, business processes, and geographic locations. From the historical data, a supervisor can make conclusions about an effectiveness of a manufacturing system utilizing the mobile RFID reader 20. For example, from the historical data, a supervisor could conclude that more mobile RFID readers are needed or additional training is needed for users. Further, for example, a supervisor could determine that a large percentage of forklifts are utilized every morning in a specific portion of a facility.

The above-described methods can be at least partially embodied in the form of one or more computer readable media having computer-executable instructions for practicing the methods. The computer-readable media can comprise one or more of the following: floppy diskettes, CD-ROMs, hard drives, flash memory, and other computer-readable media known to those skilled in the art; wherein, when the computer-executable instructions are loaded into and executed by one or more computers or computer servers, the one or more computers or computer servers become an apparatus for practicing the invention.

The system and the method for monitoring the location of a mobile RFID reader represent a substantial advantage over other systems and methods. In particular, the system and the method provide a technical effect of monitoring a location of the mobile RFID reader utilizing an active RFID tag that allows a location of the mobile RFID reader to be determined over time.

While the invention is described with reference to exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. A method for monitoring a location of a mobile RFID reader, comprising:
transmitting a first RF signal from an active RFID tag disposed on the mobile RFID reader;
receiving the first RF signal at a first stationary RFID reader;
sending a first message having data associated with the first RF signal, from the first stationary RFID reader to a computer;
determining a first location of the mobile RFID reader at a first time based on the data associated with the first RF signal, utilizing the computer; and
storing first location data indicating the first location of the mobile RFID reader in a memory device, utilizing the computer.

2. The method of claim 1, further comprising:
sending a second message having a status value associated with the mobile RFID reader or first data acquired by the mobile RFID reader from the mobile RFID reader to the computer; and
storing the status value or the first data in the memory device, utilizing the computer.

3. The method of claim 1, further comprising:
transmitting a second RF signal from the active RFID tag disposed on the mobile RFID reader;
receiving the second RF signal at the first stationary RFID reader;
sending a second message having data associated with the second RF signal, from the first stationary RFID reader to the computer;
determining a second location of the mobile RFID reader at a second time based on the data associated with the second RF signal, utilizing the computer; and
storing second location data indicating the second location of the mobile RFID reader in the memory device, utilizing the computer.

4. The method of claim 3, further comprising:
determining that the first location and the second location is in a predetermined geographical region, utilizing the computer; and
displaying an alert message on a display device when a distance between the first location and the second location is less than a predetermined distance, utilizing the computer.

5. The method of claim 3, further comprising:
displaying a map of a geographical region on a display device, utilizing the computer; and
displaying a first location marker indicating the first location of the mobile RFID reader on the map and a second location marker indicating the second location of mobile RFID reader on the map, utilizing the computer.

6. The method of claim 1, further comprising:
determining that the first location is outside of a predetermined geographical region, utilizing the computer; and
displaying an alert message on a display device indicating the first location is outside of the predetermined geographical region, utilizing the computer.

7. The method of claim 1, further comprising displaying a map of a geographical region on a display device, and displaying a location marker indicating the location of the mobile RFID reader on the map, utilizing the computer.

8. The method of claim 1, further comprising:
receiving the first RF signal at a second stationary RFID reader;
sending a second message having data associated with the first RF signal, from the second stationary RFID reader to the computer;
wherein determining the first location of the mobile RFID reader comprises calculating the first location based on the data from the first message and the data from the second message, utilizing the computer.

9. A system for monitoring a location of a mobile RFID reader, comprising:
an active RFID tag disposed on the mobile RFID reader configured to transmit a first RF signal;
a first stationary RFID reader configured to receive the first RF signal;
the first stationary RFID reader further configured to send a first message having data associated with the first RF signal to a computer;
the computer configured to determine a first location of the mobile RFID reader at a first time based on the data associated with the first RF signal; and
the computer further configured to store first location data indicating the first location of the mobile RFID reader in a memory device.

10. The system of claim 9, wherein
the mobile RFID reader computer further configured to send a second message having a status value associated with the mobile RFID reader or first data acquired by the mobile RFID reader to the computer; and
the computer further configured to store the status value or the first data in the memory device.

11. The system of claim 9, wherein
the active RFID tag further configured to transmit a second RF signal;
the first stationary RFID reader further configured to receive the second RF signal;
the first stationary RFID reader further configured to send a second message having data associated with the second RF signal to the computer;
the computer further configured to determine a second location of the mobile RFID reader at a second time based on the data associated with the second RF signal; and
the computer further configured to store second location data indicating the second location of the mobile RFID reader in the memory device.

12. The system of claim 11, wherein
the computer further configured to determine that the first location and the second location is in a predetermined geographical region; and
the computer further configured to display an alert message on a display device when a distance between the first location and the second location is less than a predetermined distance.

13. The system of claim 11, wherein
the computer further configured to display a map of a geographical region on a display device; and
the computer further configured to display a first location marker indicating the first location of the mobile RFID reader on the map and a second location marker indicating the second location of mobile RFID reader on the map.

14. The system of claim 9, wherein
the computer further configured to determine that the first location is outside of a predetermined geographical region; and
the computer further configured to induce a display device to display an alert message thereon indicating the first location is outside of the predetermined geographical region.

15. The system of claim 9, wherein the computer is further configured to induce a display device to display a map of a geographical region therein, and to display a location marker indicating the location of the mobile RFID reader on the map.

16. The system of claim 9, further comprising:
a second stationary RFID reader configured to receive the first RF signal;
the second stationary RFID reader further configured to send a second message having data associated with the first RF signal to the computer;
the computer further configured to calculate the first location based on the data from the first message and the data from the second message.
